(19) United States
(12) Patent Application Publication
(10) Pub. No.: US 2010/0073349 A1
(43) Pub. Date: Mar. 25, 2010

(54) Pixel driver with low voltage transistors

(75) Inventors: Fusao Ishii, Pittsburg, PA (US); Crist Lu, Fremont, CA (US)

Correspondence Address: BO-IN LIN, 13445 MANDOLI DRIVE, LOS ALTOS HILLS, CA, 94022, US

(73) Assignee: Silicon Quest Kabushiki-Kaisha.

(21) Appl. No.: 12/592,267

(22) Filed: Nov. 19, 2009

Related U.S. Application Data
(63) Continuation-in-part of application No. 11/600,625, filed on Nov. 16, 2006.
(60) Provisional application No. 61/199,658, filed on Nov. 19, 2008.
(60) Provisional application No. 60/845,294, filed on Sep. 18, 2006.

(51) Int. Cl. G09G 5/00

(52) U.S. Cl. 345/211

(57) ABSTRACT

An image display system implemented with a spatial light modulator (SLM) comprising a plurality of pixel elements each comprises a driver circuit. The driver circuit further comprises at least a first and second transistors cascaded with a first capacitor between a high voltage (Vh) and a ground voltage (Vg) wherein each of the first and second transistors having a breakdown voltage less than the high voltage (Vh). The first transistor receives an input signal to turn on the first and second transistors for discharging the first capacitor and pulling down an output voltage to a ground voltage (Vg) and to turn off the first and second transistors to pull up the output voltage to the high voltage (Vh) wherein each of the first and second transistor is biased to approximately half of the high voltage (Vh/2).

This application is a Non-provisional application of a Provisional application 61/199,658 filed on Nov. 19, 2008. This Application is also a Continuation in Part (CIP) Application of patent Ser. No. 11/600,625, filed on Nov. 16, 2006 and 60/845,294 dated Sep. 18, 2006. The disclosures made in these Patent Applications are hereby incorporated by reference in this Patent Application.

### TECHNICAL FIELD

This invention relates to a spatial light modulator (SLM) implemented in an image display system, arrays and control circuits to control the pixel of the SLM. More particularly, this invention relates to micromirror array and control circuits that include pixel driving circuit with new configurations and methods to drive the pixel with higher voltage using low voltage transistors.

### BACKGROUND OF THE INVENTION

Even though there are significant advances made in recent years on the technologies of implementing spatial light modulator, there are still limitations and difficulties when employed to provide high quality images display. Specifically, the difficulties may occur when the display pixels require higher voltage to drive the micromirrors. The required voltage to drive the micromirrors may be higher than the maximum breakdown voltage of transistors. Particularly, the driving voltage may be higher than the breakdown voltage of a transistors having smaller size to fit in the smaller pixel size because of the higher display resolution requirements.

Specifically, FIG. 1A shows an exemplary circuit diagram of a prior art control circuit for a micromirror according to U.S. Pat. No. 5,285,407. The control circuit includes memory cell 32. Various transistors are referred to as “M*” where * designates a transistor number and each transistor is an insulated gate field effect transistor. Transistors M5, and M7 are p-channel transistors; transistors, M6, M8, and M9 are n-channel transistors. The capacitances, C1 and C2, represent the capacitive loads presented to memory cell 32. Memory cell 32 includes an access switch transistor M9 and a latch 32a, which is the basis of the static random access switch memory (SRAM) design. All access transistors M9 in a row receive a DATA signal from a different bit-line 31a. The particular memory cell 32 to be written is accessed by turning on the appropriate row select transistor M9, using the ROW signal functioning as a wordline. Latch 32a is formed from two cross-coupled inverters, M5/M6 and M7/M8, which permit two stable states wherein state 1 is Node A high and Node B low and state 2 is Node A low and Node B high.

FIG. 1B shows an example of the circuit used for the a typical drive circuit. Two bit-lines (170-1 and 170-2) are provided to control the two FETs, i.e., respectively FET-1 and FET-2, independently. The word-line is shown as 160. When the word line is on, the signal voltage from the bit-line 170-1 is transferred to Electrode-1 shown as 120-1 and the signal voltage from 170-2 is transferred to Electrode-2, i.e., electrode 120-2. After the word-line is off, because of the capacitances, Cap-1 and Cap-2, shown as capacitor 185-1 and capacitor 185-2 respectively, the voltages of the electrodes are maintained.

The conventional configuration of driver circuit generally uses a resistor to obtain ON and OFF states as an output to provide higher driver voltage. However this type circuit requires substantially high power consumption with current flows through the resistor in order to maintain the voltages.

For these reasons, those of ordinary skill in the art are challenged with the technical difficulties to operate the spatial light modulator with lower voltage below the breakdown voltage of the transistors with reduced size of the transistor. Meanwhile, the operation of the mirror device must also maintain high level of mirror performances that requires a higher driving voltage to display images with high quality.

Therefore, a need stills exists to provide a new and improve drive circuit configuration and method of control to implement transistors operable with lower voltages while providing driving circuits to generate high driving voltage such that the above discussed difficulties may be resolved.

### SUMMARY OF THE INVENTION

It is an aspect of this invention to provide a new and improved driver circuit configuration for operating the transistors with lower voltages while still generating a higher driving voltage to drive the mirrors such that the above discussed difficulties and limitations may be overcome.

Specifically, an aspect of this invention is to provide a new and improved driver circuit configuration by stacking multiple transistors to distribute the voltage applied to these stacked transistors such that each of these transistors is maintained a voltage below the maximum breakdown voltage.

Another aspect of this invention is to provide a new and improved driver circuit configuration by adding a capacitor to avoid constant current flow through a resistor thus preventing unnecessary power consumptions such that the difficulties encountered in the prior art is overcome.

### BRIEF DESCRIPTION OF DRAWINGS

FIGS. 1A and 1B are circuit diagrams of conventional drive circuits implemented in image display system.

FIG. 2 is a functional block diagram to show the main features of present invention.

FIG. 3 is a circuit diagram to show the main features of present invention.

FIG. 4 is a circuit diagram to show the drive circuit of this invention connected to the wordline and bitline.

FIG. 5 is a circuit diagram to show an alternate drive circuit of this invention connected to the wordline and bitline.

FIG. 6 is a timing diagram to show the voltages applied to the input lines of the drive circuit of FIG. 5 to generated output voltages on two different output lines.

FIG. 7 is a circuit diagram with an additional capacitor for more flexibility of control timing and FIG. 8 are circuit diagram to show actual implementation of FIG. 7

FIG. 9 is a timing diagram to show the voltages applied to the bitline, the wordline, to illustrate the flexibility of timing of writing data to the pixel elements.

FIG. 10 is a circuit diagram with an additional connections from a second capacitor to a second wordline for applied two independent high voltage to provide more flexibility of controlling the drive circuit.

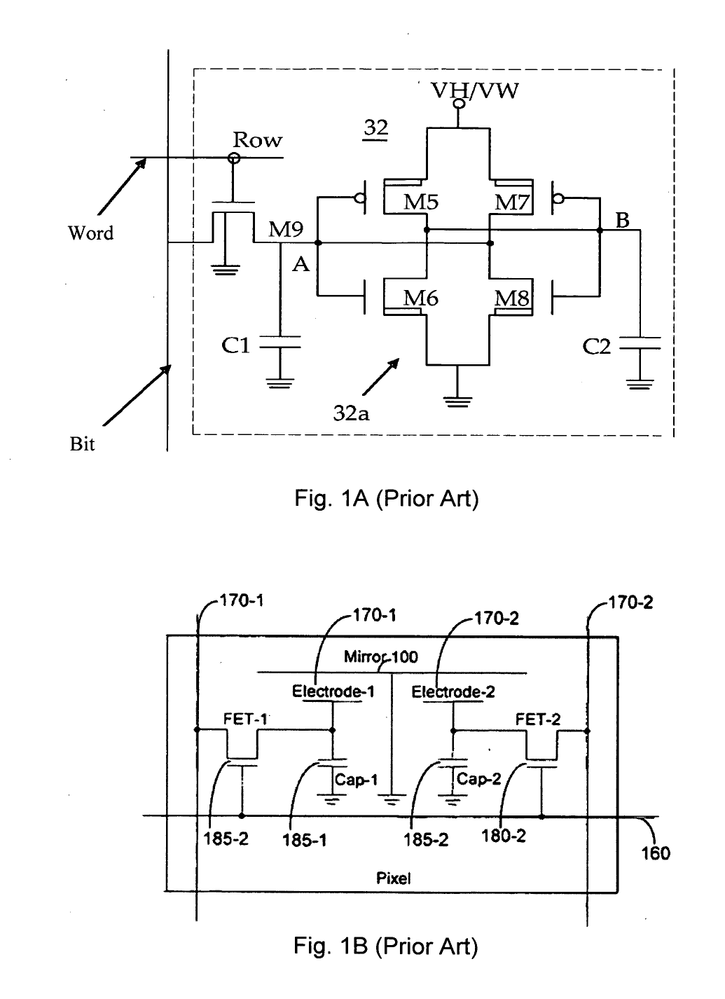

### DETAILED DESCRIPTION OF THE PREFERRED EMBODIMENTS

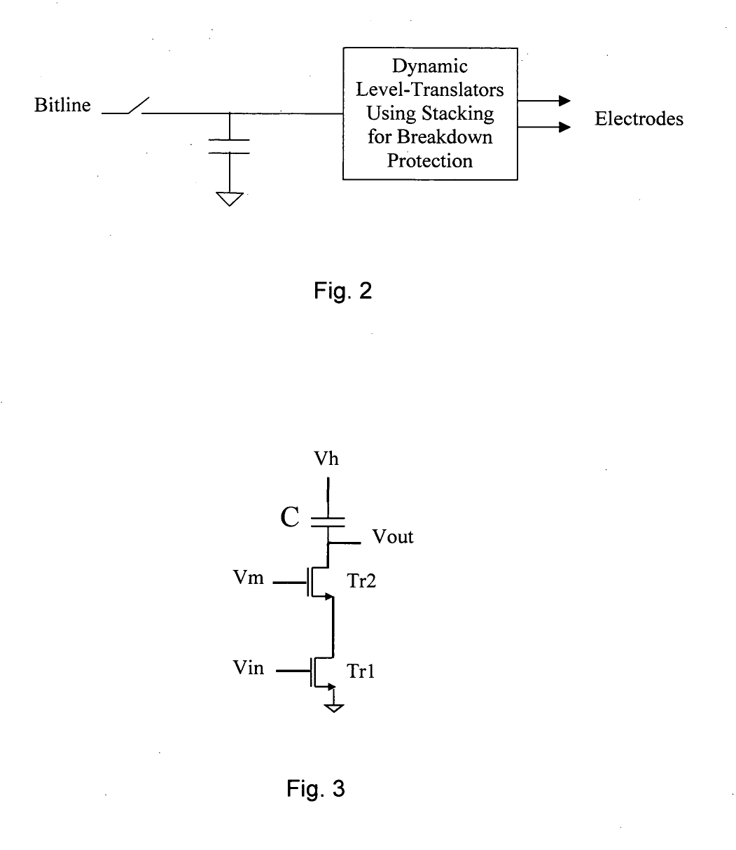

FIG. 2 is a functional block diagram to show the main features of a driver circuit implemented in a pixel element for a spatial light modulator (SLM) of an image display system of this invention. In an embodiment, the primary bitline and wordline drive circuits are operated at a five volts (5V) level while the auxiliary wordline may requires a12-volts drive circuit as will be further discussed below. The dynamic level transistors 103 are configured to have a stacked configuration for breakdown voltage protection is connected to a bitline 101. The bitline 101 is further connected to a storage capacitor 102. The drive circuit for the pixel elements is able to operate with a low voltage input to generate a high voltage output while occupies a smaller area.

FIG. 3 is a circuit diagram of an embodiment of this invention. The voltage Vin is the input signal that represents the pixel brightness. The pixel brightness is dark when Vin signal has a value of zero (0) and the pixel is bright when the Vin signal has a value of one (1). The voltage Vout is the output signal which is the voltage maintained by the capacitor, C. The voltage Vh is a high voltage which charges or discharges the capacitor C. The voltage Vh is pulled down to a ground voltage when signal is written into the capacitor C. The voltage Vm inputted to the gate of the transistor Tr2 is an intermediate voltage about Vh/2. The transistors Tr1 and Tr2 are equally biased substantially between drain and source.

An input signal is applied at Vin, the gate of the transistor Tr1, and the voltage Vh is pulled down to a ground voltage in a short period which causes the capacitor C to discharge. Then the voltage Vh is pulled up to a high voltage when the voltage applied to Vin is OFF, i.e., a zero voltage because the capacitor C is not charged. The gates of transistor Tr1 and Tr2 are turned off and the output voltage Vout is pulled up to the high voltage Vh. On the other hand, if the voltage applied to Vin is ON, the output voltage Vout is pulled down to zero volt because the voltage on the gates of Tr1 and Tr2 turn on these two transistor thus electrically short the Vout to a ground voltage. Therefore, when Vin is applied an ON signal, then the output voltage Vout=0, and if Vin is applied with an OFF signal, then the output voltage Vout=Vh, and meanwhile, the voltages between the drain and source for both transistors Tr1 and Tr2 are about Vh/2.

The purpose of the new drive circuit is to apply a lower voltage transistors, i.e., Tr1 and Tr2, to switch a higher voltage that may be higher than the punch through voltage of Tr1 and Tr2. In an embodiment, the output voltage Vout may be up to 10v. The maximum voltage between drain and source of Tr1 and Tr2 is about 6 volts. By cascading two transistors and a capacitor, the circuit shown in FIG. 3 can therefore accomplish the design goals of using low voltage transistors to generate high voltage output as that required in the spatial light modulators of the high quality image display systems.

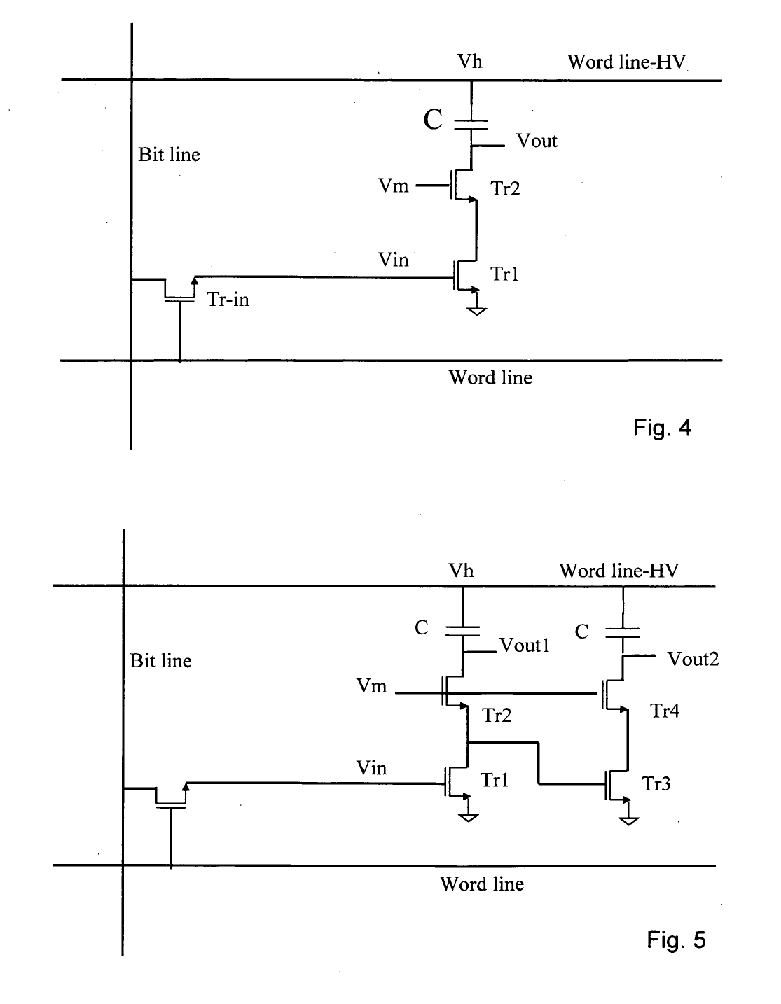

FIG. 4 shows the connections of the drive circuit in the pixel element of the SLM to the wordline and bitline. The wordline selected a row of pixel elements while the bitline is connected to the input gate Vin of the transistor Tr1 through another transistor Tr-in with a gate connected to the wordline and a source terminal connected to the bitline to input a signal through a drain terminal to the gate terminal of the transistor Tr1 as an ON-OFF signal Vin for the drive circuit of the pixel element.

FIG. 5 is a circuit diagram of another embodiment of this invention. The drive circuit is similar to the drive circuit shown in FIG. 4 except that there are two additional transistors Tr3 and Tr4 connected in parallel to the transistors Tr1 and Tr2 respectively and there are two output voltages Vout1 and Vout2 from the source terminals of Tr2 and Tr4 respectively wherein the output voltage Vout2 is complimentary to the output voltage Vout1.

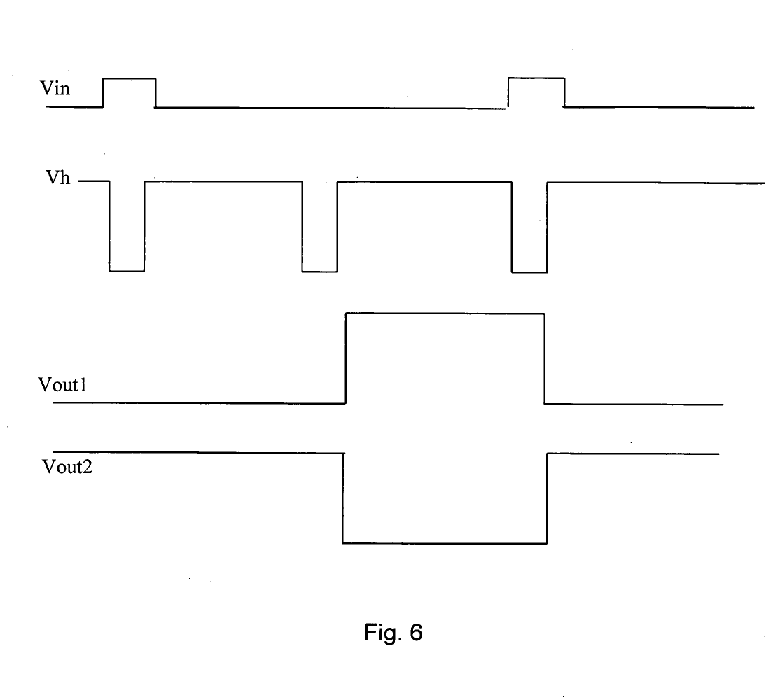

FIG. 6 is a timing diagram for showing the voltages at different terminals of the drive circuit shown in FIG. 5. As the voltage Vh is pulled down to a ground voltage the capacitor is discharged. Conversely when the voltage Vh is pulled up to high, the output voltage Vout is complimentary to Vin and the voltage is raised to Vh.

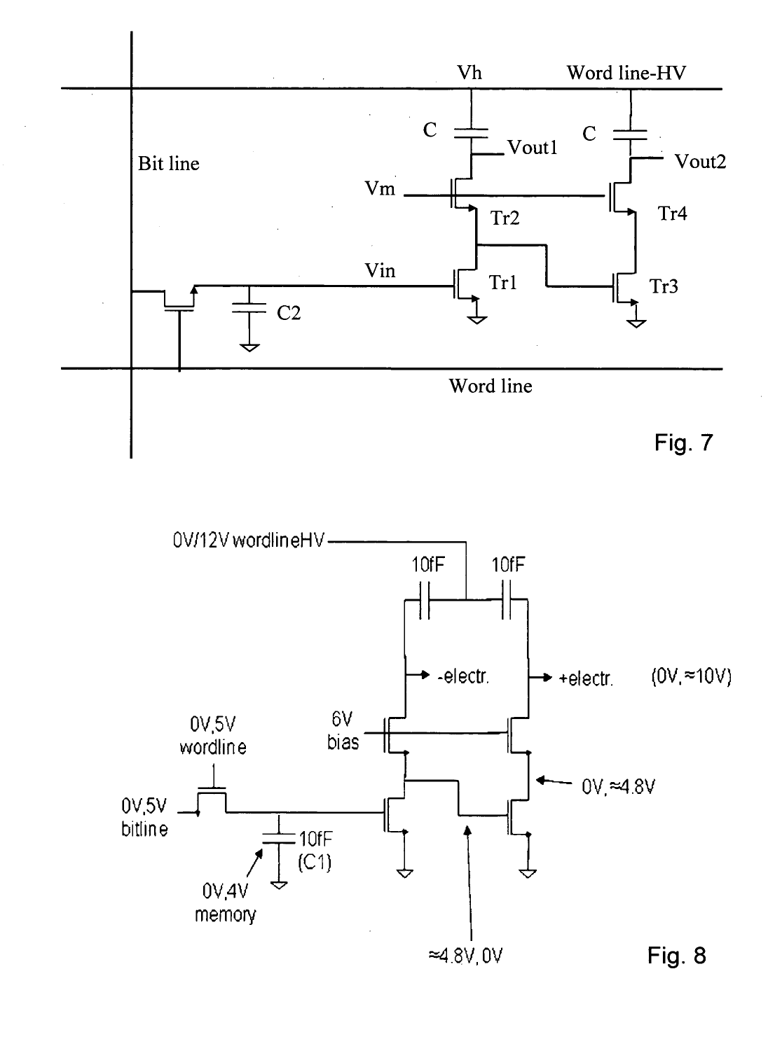

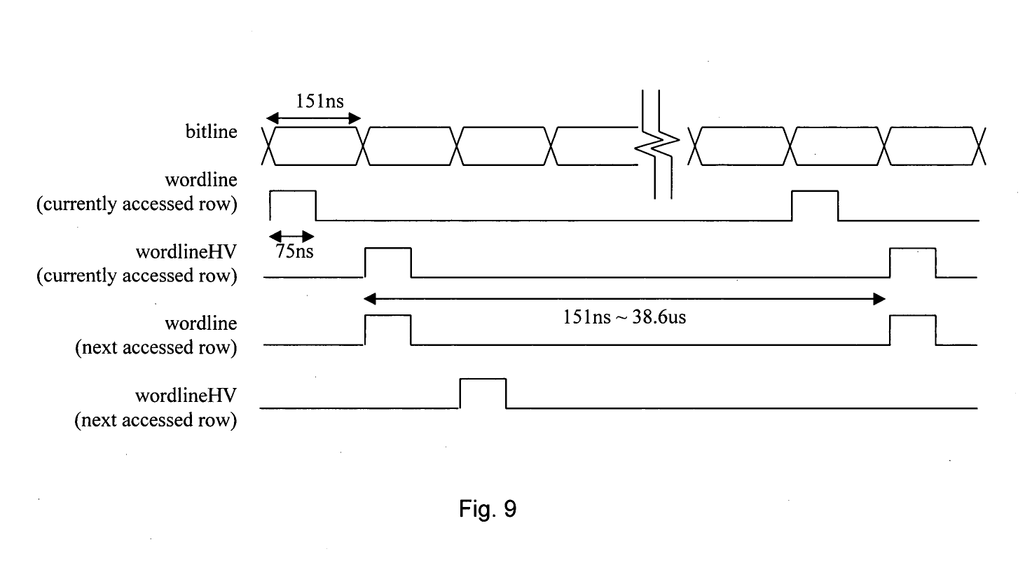

FIG. 7 is a circuit diagram of an alternate embodiment similar to the drive circuit shown in FIG. 6. One additional capacitor C2 is added to provide additional flexibility of timing for control the drive circuit. FIG. 8 shows an embodiment for a practical implementation of the circuit shown in FIG. 7. The transistors Tr1 to Tr4 may be provided with a breakdown voltage to sustain a voltage approximately 6 volts to receive an input voltage of five volts from the bitline. The drive circuit can generate an output voltage in an range of approximately zero to ten volts. FIG. 9 is a timing diagram for showing the voltage variations on the bitline and multiple wordlines for controlling the access to several rows of pixel elements. The timing of writing to the capacitor C2 may be more flexibly controlled because the writing processes are not required to be synchronized with the writing process to the capacitor C in the drive circuit for each pixel element.

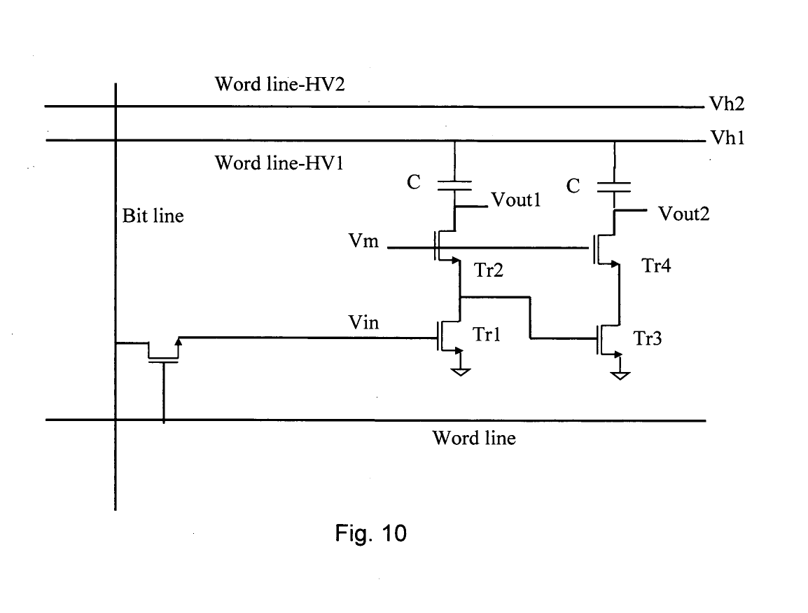

FIG. 10 is a circuit diagram for showing another embodiment of this invention. The capacitor connected to the transistors Tr1 and Tr2 is connected to a wordline providing a voltage HV1 and the capacitor connected to the transistors Tr3 and Tr4 is connected to the second wordline to supply a second voltage Vh2. The voltages Vh1 and Vh2 can be controlled independently thus providing more flexibility to control the drive circuit to achieve higher image display performance.

According to above descriptions, this invention discloses an image display system implemented with a spatial light modulator (SLM) comprising a plurality of pixel elements each comprises a driver circuit. The driver circuit further comprises at least a first and second transistors cascaded with a first capacitor between a high voltage (Vh) and a ground voltage (Vg) wherein each of the first and second transistors having a breakdown voltage less than the high voltage (Vh). The first transistor receives an input signal to turn on the first and second transistors for discharging the first capacitor and pulling down an output voltage to a ground voltage (Vg) and to turn off the first and second transistor to pull up the output voltage to the high voltage (Vh) wherein each of the first and second transistor is biased to approximately half of the high voltage (Vh/2). The image display system of claim 1 wherein the driver circuit further comprising: In another embodiment, the driver circuit further includes a third and a fourth transistors cascaded with a second capacitor between the high voltage and a ground voltage wherein the third and fourth transistors and the second capacitor are complimentary to the first and second transistors with the first capacitors to generate an second output voltage complimentary to the output voltage from the first and second transistors with the first capacitor. In another embodiment, the spatial light modulator (SLM) further comprises a mirror device and each of the pixel elements further comprises a micromirror controlled by the drive circuit. In another embodiment, the SLM further comprises a wordline connected to the high voltage and to the first capacitor of the drive circuit; and a bit line connected to a gate of the first transistor for receiving an input signal to turn on and off the first and second transistors. In another embodiment, the SLM further comprises an input transistor having a gate connected to the wordline and a source connected to the bit line with a drain connected to the gate of the first transistor for receiving an input signal from the bit line when selected by a row-selection signal on the wordline. In another embodiment, each of the pixel elements an additional drive circuit as a second drive circuit; and each of the pixel elements further comprising two sets of electrodes each connected to the driver circuit and the additional driver circuit a first driver circuit and the second driver circuit. In another embodiment, the second driver circuit is further connected to the first driver circuit to receive an input signal received from a bitline whereby the pixel element is operable with a single bitline. In another embodiment, illustrated in FIG. 10, the two electrodes have independent voltage supplies to each of the capacitors and the pixel can have at least (ON,OFF), (OFF,ON) and (OFF,OFF) states for the two sets of electrodes.

According to above descriptions, this invention discloses an image display system implemented with a spatial light modulator (SLM) comprises a plurality of pixel elements each comprises a driver circuit. The driver circuit further comprises at least a first and second transistors cascaded with a high value resistance connected to a static supply voltage between a high voltage (Vh) and a ground voltage (Vg) wherein each of the first and second transistors having a breakdown voltage less than the high voltage (Vh). The first transistor receives an input signal to turn on the first and second transistors for discharging the first capacitor and pulling down an output voltage to a ground voltage (Vg) and to turn off the first and second transistor to stop discharging the first capacitor to pull up the output voltage to the high voltage (Vh) wherein each of the first and second transistor is biased to approximately half of the high voltage (Vh/2). In an embodiment, the high value resistance is formed as a low doped silicon.

Although the present invention has been described in terms of the presently preferred embodiment, it is to be understood that such disclosure is not to be interpreted as limiting. Various alterations and modifications will no doubt become apparent to those skilled in the art after reading the above disclosure. Accordingly, it is intended that the appended claims be interpreted as covering all alterations and modifications as fall within the true spirit and scope of the invention.

I claim:

1. An image display system implemented with a spatial light modulator (SLM) comprising a plurality of pixel elements each comprises a driver circuit wherein the driver circuit further comprising:
at least a first and second transistors cascaded with a first capacitor between a high voltage (Vh) and a ground voltage (Vg) wherein each of said first and second transistors having a breakdown voltage less than the high voltage (Vh); and
the first transistor receives an input signal to turn on the first and second transistors for discharging the first capacitor and pulling down an output voltage to a ground voltage (Vg) and to turn off the first and second transistor to pull up the output voltage to the high voltage (Vh) wherein each of the first and second transistor is biased to approximately half of the high voltage (Vh/2).

2. The image display system of claim 1 wherein the driver circuit further comprising:
a third and a fourth transistors cascaded with a second capacitor between the high voltage and a ground voltage wherein said third and fourth transistors and said second capacitor are complimentary to said first and second transistors with said first capacitors to generate an second output voltage complimentary to the output voltage from the first and second transistors with the first capacitor.

3. The image display system of claim 1 wherein:
the spatial light modulator (SLM) further comprising a mirror device and each of said pixel elements further comprises a micromirror controlled by the drive circuit.

4. The image display system of claim 1 further comprising:
a wordline connected to the high voltage and to the first capacitor of said drive circuit; and
a bit line connected to a gate of said first transistor for receiving an input signal to turn on and off the first and second transistors.

5. The image display system of claim 4 further comprising:
an input transistor having a gate connected to the wordline and a source connected to the bit line with a drain connected to the gate of the first transistor for receiving an input signal from the bit line when selected by a row-selection signal on said wordline.

6. The image display system of claim 1 wherein each of said pixel elements further comprising:
an additional drive circuit as a second drive circuit; and
each of said pixel elements further comprising two sets of electrodes each connected to the driver circuit and the additional driver circuit a first driver circuit and the second driver circuit.

7. The image display system of claim 6 wherein:
the second driver circuit is further connected to the first driver circuit to receive an input signal received from a bitline whereby the pixel element is operable with a single bitline.

8. The image display system of claim 6 wherein
said at least two electrodes have independent voltage supplies to each of the capacitors and said pixel can have at least (ON,OFF), (OFF,ON) and (OFF,OFF) states for said two sets of electrodes.

9. An image display system implemented with a spatial light modulator (SLM) comprising a plurality of pixel elements each comprises a driver circuit wherein the driver circuit further comprising:
at least a first and second transistors cascaded with a high value resistance connected to a static supply voltage between a high voltage (Vh) and a ground voltage (Vg) wherein each of said first and second transistors having a breakdown voltage less than the high voltage (Vh); and
the first transistor receives an input signal to turn on the first and second transistors for discharging the first capacitor and pulling down an output voltage to a ground voltage (Vg) and to turn off the first and second transistor to stop discharging the first capacitor to pull up the output voltage to the high voltage (Vh) wherein each of the first and second transistor is biased to approximately half of the high voltage (Vh/2).

10. The image display system of claim 9 wherein:
the high value resistance is formed as a low doped silicon.

11. The image display system of claim 2 wherein:
said first capacitor is connected to a first high voltage supply and said second capacitor is connected to a second high voltage supply which is independent to said first high voltage supply.
